(19) United States
(12) Patent Application Publication
(10) Pub. No.: US 2008/0128237 A1
(43) Pub. Date: Jun. 5, 2008

(54) Clutch arrangement for a motor vehicle

(75) Inventors: Peter Fenn, Waigolshausen (DE); Rudiger Lotze, Schweinfurt (DE); Arthur Schroder, Hambach (DE); Jorg Sudau, Niederwerrn (DE); Christian Struck, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/906,838

(22) Filed: Oct. 4, 2007

(30) Foreign Application Priority Data
Oct. 6, 2006 (DE) 10 2006 047 296.9

(51) Int. Cl. F16D 13/72

(52) U.S. Cl. 192/70.12

(57) ABSTRACT

A clutch device for a motor vehicle is disclosed. The clutch device includes a housing connected to a drive for rotation in common around an axis of rotation and fillable with a fluid; a first friction element carrier having first internal teeth; first friction elements each comprising a plurality of first external teeth and connected non-rotatably to the first friction element carrier with the first external teeth engaging the first internal teeth, each first friction element and the first friction element carrier defining a first fluid pass-through area; a second friction element carrier having second external teeth; second friction elements each comprising a plurality of second internal teeth and connected non-rotatably the second friction element carrier with the second internal teeth engaging the second external teeth, each second friction element and the second friction element carrier defining a second fluid pass-through area.

### BACKGROUND OF THE INVENTION

1. Field of the Invention

The present invention relates to a clutch arrangement for a motor vehicle, comprising a housing, which is to be connected for rotation in common around an axis of rotation to a drive component and which is or can be filled with working fluid. In this housing, a first group of friction elements is connected nonrotatably to a first friction element carrier, and a second group of friction elements is connected nonrotatably to a second friction element carrier. The friction elements of the second friction element group can be brought into frictional engagement with the friction elements of the first friction element group so that torque can be transmitted.

2. Description of the Related Art

A clutch arrangement of this type, which is also known as a wet-running clutch or as a plate clutch, is described in U.S. Pat. No. 7,216,750. In the areas where the various friction elements are connected nonrotatably to their assigned friction element carrier by means of external or internal sets of teeth, pass-through areas or channels are formed, through which the fluid, which flows around the friction elements during torque-transmitting operation and especially during the times that the clutch is operating with slippage, can pass. In this way, fluid circulation is produced in the area of the frictionally interacting surfaces, and this circulation ensures the rapid dissipation of the heat.

### SUMMARY OF THE INVENTION

An object of the present invention is to elaborate a clutch arrangement of this type in such a way that the dissipation of heat from the area of the friction elements which can be brought into frictional interaction with each other is improved.

According to the present invention, this object is achieved by a clutch arrangement for a motor vehicle, including a housing, which is to be connected for rotation in common around an axis of rotation to a drive component and which is or can be filled with working fluid, and a first group of friction elements, which is connected nonrotatably to a first friction element carrier. The first friction element carrier has a set of internal teeth and the friction elements of the first friction element group have a set of external teeth, which are engaged with the set of internal teeth on the first friction element carrier. In the area of these engaged sets of teeth, a first fluid pass-through is formed between the first friction element carrier and the friction elements of the first friction element group. The ratio V₁ of the area of the first fluid pass-through to a first maximum pass-through area is in the range of 0.3≦V₁≦0.7. The first maximum pass-through area is formed as a ring-shaped area between the root circle of the internal set of teeth on the first friction element carrier and the root circle of the external set of teeth on the friction elements of the first friction element group. The clutch arrangement also includes a second group of friction elements connected nonrotatably to a second friction element carrier, which second group can be brought into frictional interaction with the friction elements of the first friction element group for the transmission of the torque. The second friction element carrier has a set of external teeth and the friction elements of the second friction element group have a set of internal teeth, which are engaged with the external teeth of the second friction element carrier. In the area of these two mutually engaging sets of teeth, a second fluid pass-through is formed between the second friction element carrier and the friction elements of the second friction element group. The ratio V₂ of the area of the second fluid pass-through to a second maximum pass-through area is in the range of 0.1≦V₂≦0.5. The second maximum pass-through area is formed as a ring-shaped area between the root circle of the set of external teeth on the second friction element carrier and the root circle of the set of internal teeth on the friction elements of the second friction element group.

It has been found that, both for the area in which the friction elements of the first friction element group are connected nonrotatably to the assigned first friction element carrier and for the area in which the friction elements of the second friction element group are connected nonrotatably to the second friction element carrier, optimization can be achieved in each case with respect to the ability of the fluid to flow through by selecting the ratio between the provided fluid pass-through area and the maximum possible pass-through area for the fluid so that it is within a certain range of values. It is obvious that it will be especially advantageous to assign a value or value range which has been optimized in this way for the ratio in question both to the first friction element carrier and the first friction element group and to the second friction element carrier and the second friction element group. Nevertheless, the dissipation of heat can still be improved even if this optimization of the area ratio is applied to only one of these areas under consideration.

The first friction element carrier can be designed to rotate in common with the housing around the axis of rotation and can be provided, for example, by the housing itself.

The second friction element carrier can be designed to rotate in common with a takeoff hub around the axis of rotation. To damp torsional vibrations, it is advantageous to provide a torsional vibration damper arrangement here as a connecting element between the second friction element carrier and the takeoff hub.

In the inventive clutch arrangement, the number of teeth of the internal set on the first friction element carrier can be larger than the number teeth of the external set on the friction elements of the first friction element group. In this way, through the elimination of some of the teeth from the external set, the size of the fluid passage can be increased to provide the desired ratio without significantly impairing the strength of the connection for rotation in common.

In a corresponding manner, the number of teeth of the external set on the second friction element carrier can be greater than the number of teeth of the internal set on the friction elements of the second friction element group.

So that the various optimal ranges for the area ratios in question can be provided without impairing the strength of the connection for rotation in common, it is proposed that the radial engagement depth of the internal teeth on the first friction element carrier with the external teeth of the friction elements of the first friction element group be less than the radial engagement depth of the external teeth of the second friction element carrier with the internal teeth of the friction elements of the second friction element group.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is described in detail below with reference to the attached drawings:

FIG. 1 shows a partial longitudinal cross section of a wet-running friction clutch;

FIG. 2 shows, in isolation, a view of the connection between friction elements of a second friction element group and an associated second friction element carrier; and

FIG. 3 shows, in isolation, a view of the connection between friction elements of a first friction element group and an associated first friction element carrier.

### DETAILED DESCRIPTION OF THE PRESENTLY PREFERRED EMBODIMENTS

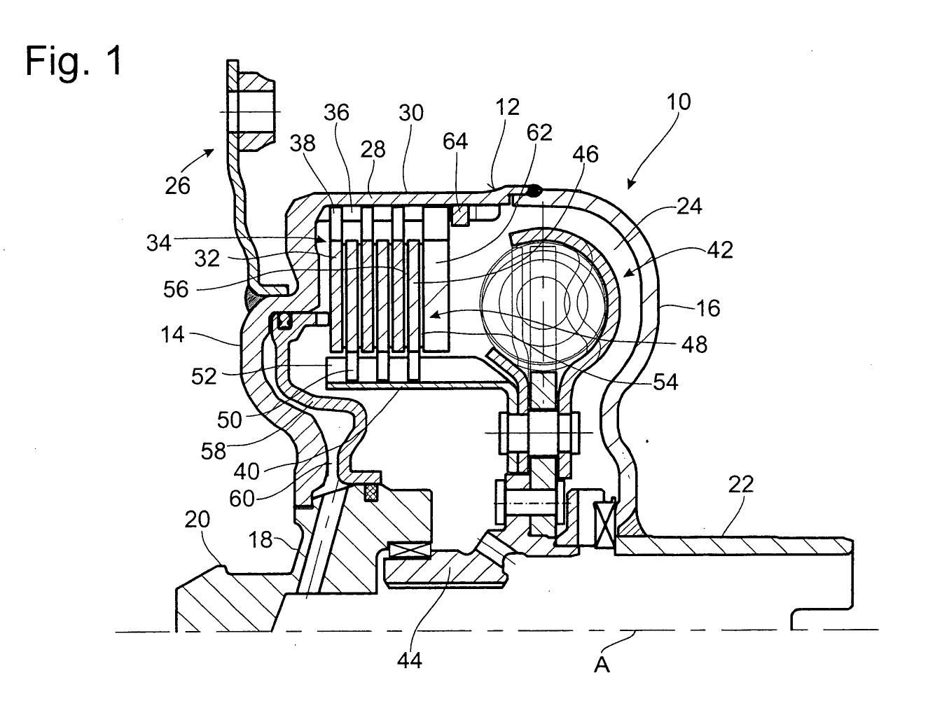

FIG. 1 shows a wet-running friction clutch (also frequently called a wet-running plate clutch) designated by the reference number 10. The clutch 10 comprises a housing arrangement 12 with a housing shell 14 on the engine side and a housing shell 16 on the gearbox side. The two shells are welded to each other in their radially outer areas. A housing hub 18, furthermore, is welded to the engine-side housing shell 14; this hub 18 can be supported radially by way of a bearing journal 20 in a drive shaft, such as the crankshaft of an internal combustion engine. A drive hub 22 can be permanently connected by welding, for example, to the gearbox-side housing shell 16; this hub projects into a gearbox housing, where it drives a fluid pump to convey working fluid such as oil into an interior space 24 of the housing arrangement 12.

A connecting arrangement 26 is also permanently connected to the housing shell 14. This arrangement can be used to establish a connection between the housing and a drive component such as the crankshaft of an internal combustion engine.

A section 28 of the housing shell 14 which extends essentially in a direction parallel to the axis of rotation A forms a first friction element carrier 30, to which friction elements 32 of a first friction element group 34 are connected nonrotatably but with freedom of axial movement. For this purpose, the friction element carrier 30 has a set of internal teeth 36, whereas the friction elements 32 of the first group 34 have sets of external teeth 38, which mesh with the set of internal teeth 36.

A second friction element carrier 40 is connected by a torsional vibration damper 42 to a takeoff hub 44 and can be connected by way of this hub to a takeoff shaft, such as a gearbox input shaft, for rotation in common around the axis of rotation A. Each of the friction elements 46 of a second friction element group 48 has a set of internal teeth 50, by which these friction elements 46 mesh with a set of external teeth 52 on the second friction element carrier 40. The second group 48 of friction elements 46 are therefore connected to the second carrier 40 for rotation in common around the axis of rotation but are still able to shift position on the carrier 40 in the direction parallel to the axis of rotation A.

In the case illustrated here, the friction elements 46 of the second friction element group 48 carry friction linings 54, 56 on both axial sides, whereas the friction elements 32 of the first friction element group 34 do not have friction linings. Of course, this arrangement could be reversed, or it would be possible for the friction elements 32, 46 of each of the groups 34 and 48 to have a friction lining on one axial side.

In its radially outer area, a ring-like piston element 58 is guided in a fluid-tight but axially movable manner with respect to the engine-side housing shell 14, and in the radially inner area it is guided on the housing hub 18. By increasing the fluid pressure in a space 60, this piston element can be pushed toward the two groups 34, 48 of friction elements to bring them into frictional engagement with each other. The force is absorbed by an abutment plate 62, which is connected nonrotatably to the first friction element carrier 30 and which is also secured in the axial direction by a locking element 64.

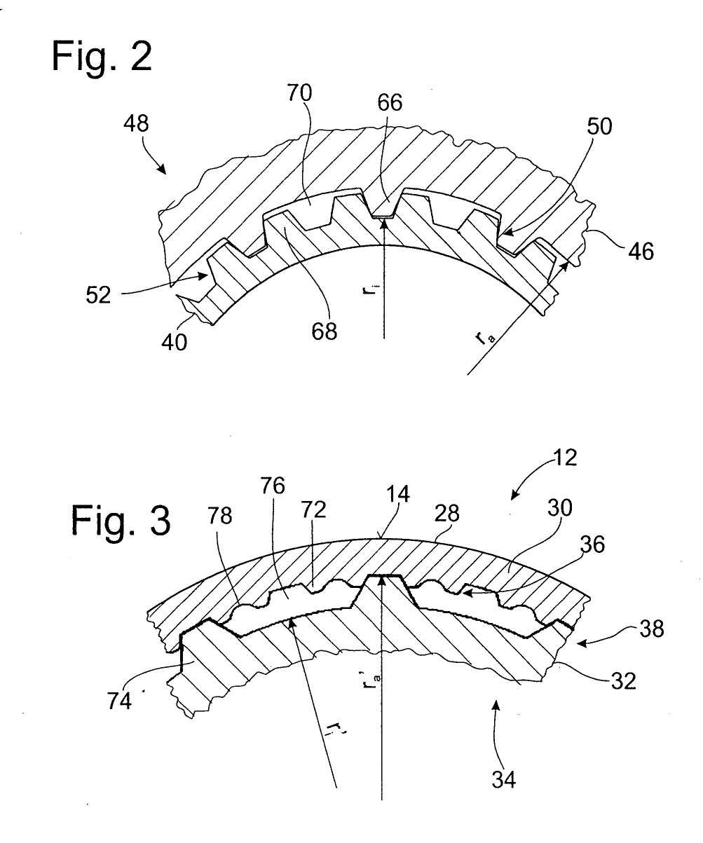

FIG. 2 shows in isolation the area in which the set of external teeth 52 on the second friction element carrier 40 meshes with the set of internal teeth 50 on one friction element 46 of the second friction element group 48. It can be seen first that each of the sets of teeth 50, 52 has a plurality of teeth 66, 68, which are arranged in a row in the circumferential direction and which mesh with each other preferably in such a way that only a small amount of rotational play is present between the second friction element carrier 40 and the friction elements 46. For each of the sets of teeth 50, 52, i.e., for the teeth 66, 68 of those sets of teeth, a so-called root circle can be defined. The root circle of the set of internal teeth 50 of the friction elements 46 is defined by a circle with the radius rₐ, which defines the radial starting point or radially outer end of the teeth 66 of the internal set of teeth 50. The radial length of the teeth 66 of the set of internal teeth 50 can therefore be measured from this root circle with the radius rₐ. In a corresponding manner, the root circle of the set of external teeth 52 with the teeth 68 has a radius rᵢ and therefore defines the radially inner end or radially inner starting point of the teeth 68 of the set of external teeth 52. The two root circles rₐ, rᵢ define an imaginary or maximum possible pass-through area between the second friction element carrier 40 and the friction elements 46 of the second friction element group 48, where this pass-through area is defined as the ring-shaped area between the two root circles with the diameters rₐ and rᵢ. The pass-through area which can actually be obtained for the passage of fluid, however, is in fact smaller than this ring-shaped area defined between the two root circles with the radii rₐ and rᵢ, because parts of this maximum possible pass-through area are occupied by the teeth 66 and 68 of the sets of teeth 50 and 52.

It has now been discovered that, with respect to the nonrotatable connection of the plates or friction elements 46 of the second friction element group 48, an area ratio V₂ between the area of the actually obtained fluid pass-through 70 here and the maximum possible pass-through area, i.e., the ring-shaped area formed between the circles with the radii rₐ and rᵢ, is optimally in the range of 0.1≦V₂≦0.5. When the area ratio V₂ is selected to be within this range, the connection for rotation in common will be sufficiently stable, and at the same time the circulating fluid will have optimum ability to flow in the axial direction through the area of the friction elements 46, 32.

FIG. 3 shows the area of the connection between the friction elements 32 of the first friction element group 34 and the first friction element carrier 30, that is, the axially oriented section 28 of the engine-side housing shell 14. Here, too, it can be seen that the set of internal teeth 36 of the first friction element carrier 30 has a plurality of teeth 72 arranged in a row in the circumferential direction, which mesh with the teeth 74 of the set of external teeth 38 of the friction elements 32 in such a way that there is essentially no circumferential play, even though the freedom of axial movement is preserved.

Here, too, it is possible to define root circles for the teeth 72 and 74 of the sets of teeth 36, 38, where the root circle of the set of internal teeth 36 of the first friction element carrier 30 is a circle with the radius rₐ′ and the root circle of the set of external teeth 38 of the friction elements 32 is defined by a circle with the radius rᵢ′. Here, too, a ring-shaped area is defined between the two root circles with these radii rₐ′ and rᵢ′, which can be defined as the theoretical or maximum possible fluid pass-through area. The area actually present for a fluid pass-through 76 in this area, however, is smaller because of the teeth 72, 74, which extend radially into this ring-shaped area. It has been found that an area ratio V₁ between this actually existing area of the fluid pass-through 76 and the maximum possible pass-through area is especially advantageous when it is in the range of 0.3≦V₁≦0.7. It can be seen that this ratio V₁, which has been pushed into a somewhat higher range than that of the ratio V₂ discussed previously on the basis of FIG. 2, can be achieved in several ways, one of them being to provide the teeth 72 of the set of external teeth 36 of the first friction element carrier with radial depressions 78, which thus produce an increase in the area of the fluid pass-through 76. As also in the case of the area shown in FIG. 2, the area ratio V₁ or V₂ to be provided can be achieved in several ways, one of them being to provide the two sets 36, 38; 50, 52 of meshing teeth with different numbers of teeth. Thus, both radially on the inside and radially on the outside, the friction element carrier 30, 40 in question will have a larger number of teeth than the friction elements 32, 46 to be connected to it; for example, it can have twice as many teeth. Specifying the radial length of the teeth in question, starting from the associated root circle, also influences, of course, the area of the associated fluid pass-through 70, 76, where, in a comparison between FIGS. 2 and 3, it can be seen that the radial length of the teeth 68 of the set of external teeth 52 of the second friction element carrier 40 is much larger than the radial dimension of the teeth 72 of the set of internal teeth 36 of the first friction element carrier 30. Because the area of the connection for rotation in common visible in FIG. 3 is located much farther out radially than that shown in FIG. 2, a much larger number of teeth can be brought into meshing engagement with each other in this radially farther-out area without changing the spacing between the teeth. This means in turn that the sets of teeth in this radially outer area do not have to engage with each other as deeply as the sets of teeth radially farther inward, which also have fewer teeth because of the smaller circumference.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch device for a motor vehicle, comprising:
a housing connected to a drive for rotation in common around an axis of rotation, the housing being fillable with a fluid;
a first friction element carrier comprising a plurality of first internal teeth sharing a first common root circle;
a plurality of first friction elements disposed in the housing, each first friction element comprising a plurality of first external teeth sharing a second common root circle, each first friction element being connected non-rotatably to the first friction element carrier with the first external teeth engaging the first internal teeth, each first friction element and the first friction element carrier defining a first fluid pass-through area therebetween;
a second friction element carrier having a plurality of second external teeth sharing a third common root circle;
a plurality of second friction elements disposed in the housing, each second friction element comprising a plurality of second internal teeth sharing a fourth common root circle, each second friction element being connected non-rotatably to the second friction element carrier with the second internal teeth engaging the second external teeth, each second friction element and the second friction element carrier defining a second fluid pass-through area therebetween,
wherein the first friction elements and the second friction elements are configured to be frictionally engageable with each other for torque transmission,
wherein the first common root circle and the second common root circle define a ring-shaped first maximum pass-through area therebetween,
wherein the third common root circle and the fourth common root circle define a ring-shaped second maximum pass-through area therebetween, and
wherein at least one of a ratio V1 of the first fluid pass-through area to the first maximum pass-through area satisfies 0.3≦V1≦0.7 and a ratio V2 of the second fluid-pass-through area to the second maximum pass-through area satisfied 0.1≦V2≦0.5.

2. The clutch device of claim 1, wherein the first friction element carrier is configured to rotate in common with the housing around the axis of rotation.

3. The clutch device of claim 2, wherein the first friction element carrier and the housing are integrally formed.

4. The clutch device of claim 1, further comprising a takeoff hub, the second friction element carrier being configured to rotate in common with the takeoff hub around the axis of rotation.

5. The clutch device of claim 4, further comprising a torsional vibration damper, the second friction element carrier being coupled to the takeoff hub by the torsional vibration damper.

6. The clutch device of claim 1, wherein the first internal teeth have a number which is greater than a number of the first external teeth.

7. The clutch device of claim 1, wherein the second external teeth have a number which is greater than a number of the second internal teeth.

8. The clutch device of claim 1, wherein a depth to which the first internal teeth radially engage the first external teeth is less than a depth to which the second external teeth radially engage the second internal teeth.

9. The clutch device of claim 1, wherein a ratio of the radial length of the first external teeth to the radial length of the first internal teeth is greater than a ratio of the radial length of the second internal teeth to the radial length of the second external teeth.
